(19) United States
(12) Patent Application Publication
(10) Pub. No.: US 2008/0025178 A1
(43) Pub. Date: Jan. 31, 2008

(54) Data recording apparatus, recording medium and error detection method

(75) Inventors: Yasuhiro Takase, Kanagawa (JP); Yoshiteru Ishida, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/881,188

(22) Filed: Jul. 25, 2007

(30) Foreign Application Priority Data
Jul. 25, 2006 (JP) 2006-202307

(51) Int. Cl. G11B 5/58

(52) U.S. Cl. 369/53.42

(57) ABSTRACT

Embodiments of the present invention provide a data recording apparatus, recording medium and error detection method capable of detecting an error while a ratio of an error detecting code to a data string recorded in the recording medium is restrained. According to one embodiment, since a recording composite code CX smaller in size than the case where error detecting codes generated from data sectors are connected to the data sectors (small sectors) D0 to D7 is added to data string, enough capacity is ensured to record the user data on a magnetic disk.

### CROSS-REFERENCES TO RELATED APPLICATIONS

The instant nonprovisional patent application claims priority to Japanese Patent Application No. 2006-202307 filed Jul. 25, 2006 and incorporated by reference in its entirety herein for all purposes

### BACKGROUND OF THE INVENTION

A data recording apparatus such as a magnetic disk apparatus uses a technique in which, when user data is recorded on a recording medium, error detecting codes are added to the user data and, when the user data is reproduced from the recording medium, a data error (defect) occurring during transmission in a system or on a recording medium is corrected and checked in accordance with the codes. Error detecting codes generally known include, for example, an error correcting code (ECC) and a cyclic redundancy check (CRC) code.

The error detecting code, however, is added to each data sector (with 512 bytes, for example,) comprising a user data and recorded on a recording medium. For this reason, the recording medium to record a user data is decreased in capacity, impeding increase in the capacity of the recording medium.

Lately, for example, in Japanese Patent Publication No. 2002-23966, a new format has been proposed in which a predetermined number of data sectors (small sector) are taken to be a recording unit (large sector) for the recording medium, to meet a demand for increase in the capacity of the recording medium. In this proposal, however, error detecting codes are probably added both to the small and the large sector, causing the above problem to be more serious.

### BRIEF SUMMARY OF THE INVENTION

Embodiments according to the present invention is provide a data recording apparatus, recording medium and error detection method capable of detecting an error while a ratio of an error detecting code to a data string recorded in the recording medium is restrained. According to the particular embodiment of FIG. 5, since a recording composite code CX smaller in size than the case where error detecting codes generated from data sectors are connected to the data sectors (small sectors) D0 to D7 is added to data string, enough capacity is ensured to record the user data on a magnetic disk.

### BRIEF DESCRIPTION OF THE DRAWINGS

FIG. 1 is a block diagram illustrating an example of configuration of a data recording apparatus.

FIG. 2 is a block diagram illustrating a principal part in FIG. 1.

FIG. 3 is a block diagram illustrating a principal part in FIG. 2.

FIG. 4 is a flowchart illustrating an example of operation of the data recording apparatus.

FIG. 5 is a drawing for describing a recording operation.

FIG. 6 is a drawing for describing computation.

FIG. 7 is a drawing for describing a reproducing operation.

### DETAILED DESCRIPTION OF THE INVENTION

Embodiments in accordance with the present invention relate to a data recording apparatus, recording medium and error detection method capable of detecting an error occurring while data is transmitted in a system or occurring on a recording medium.

Embodiments of the present invention have been made in view of the above problem and has for a purpose to provide a data recording apparatus, recording medium and error detection method capable of detecting an error while a ratio of an error detecting code to a data string recorded in the recording medium is restrained.

To solve the above problems, the data recording apparatus according to embodiments of the present invention comprises: a recording side code generating unit for uniquely generating a code from each data sector; a recording side computing unit for performing a predetermined computation on the code to compute a recording composite code small in size than the codes connected with each other; a data string generating unit for generating a data string in which the recording composite code is added to the aggregation of each data sector; a data recording unit for recording the data string on a recording medium; a data reproducing unit for reproducing the data string from the recording medium; a reproducing side code generating unit for generating a verifying code from each data sector included in the reproduced data string in the same manner as the recording side code generating unit; a reproducing side computing unit for computing a verifying composite code from the verifying code in the same manner as the recording side code generating unit; and an error detecting unit for comparing the recording composite code with the verifying composite code to detect that an error occurs in the data sector if both fail to coincide with each other.

In the data recording apparatus according to embodiments of the present invention, the recording side code is characterized by generating an error correcting code and/or an error checking code smaller in size than the data sector as the code.

In the data recording apparatus according to embodiments of the present invention, a predetermined number of data sectors are taken to be a recording unit for the recording medium, and the recording side computing unit computes the recording composite code for each of the predetermined number of data sectors.

The recording medium according to embodiments of the present invention is characterized in that a data string in which a recording composite code is added on the aggregation of each data sector is recorded on the recording medium, the recording composite code being computed in such a manner that a predetermined computation is executed on a code uniquely generated from each data sector to compose the data sectors and therefore being smaller in size than the codes connected with each other.

A method of detecting an error according to embodiments of the present invention comprises the steps of: uniquely generating a code from each data sector on a recording side; performing a predetermined computation on the code on the recording side to compute a recording composite code smaller in size than the codes connected with each other; generating a data string in which the recording composite code is added to the aggregation of each data sector; recording the data string on a recording medium; reproducing the data string from the recording medium; generating a verifying code from each data sector included in the reproduced data string in the same manner as the recording side code generating unit; computing a verifying composite code from the verifying code on the reproducing side in the same manner as the recording side computing unit; and comparing the recording composite code with the verifying composite code to detect that an error occurs in the data sector if both fail to coincide with each other.

According to embodiments of the present invention described above, an error can be detected while a ratio of an error detecting code to a data string recorded in the recording medium is restrained.

Embodiments of the present invention are described with reference to drawings. Although the following describes a magnetic disk apparatus as one example of a data recording apparatus, the present invention is not limited to this, but applicable to other data recording apparatuses such as an optical disk apparatus.

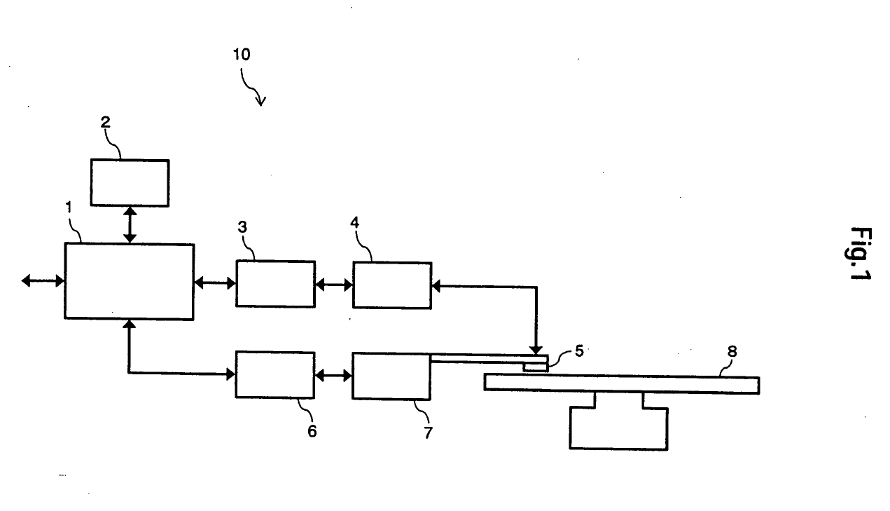

FIG. 1 is a block diagram illustrating an example of configuration of a data recording apparatus 10 constituted as a magnetic disk apparatus. The data recording apparatus 10 includes a micro processing unit/hard disk controller (MPU/HDC) 1, memory 2, read/write (R/W) channel 3, head amplifier 4, magnetic head 5, driver 6, voice coil motor 7 and magnetic disk 8 being a recording medium.

The MPU/HDC 1 controls the entire apparatus and executes an interface control with outside hosts.

The memory 2 includes a ROM which stores programs and data to operate the MPU/HDC 1 and a RAM which operates as a work memory of the MPU/HDC 1. The memory 2 is also used as a buffer memory for data recorded on and reproduced from the magnetic disk 8.

When data is recorded, the R/W channel 3 applies a code modulation to a recording signal input from the MPU/HDC 1 and outputs the code-modulated signal to the head amplifier 4. When data is reproduced, the R/W channel 3 applies a code demodulation to a reproduced signal output from the head amplifier 4 and outputs the code-demodulated to the MPU/HDC 1.

When data is recorded, the head amplifier 4 amplifies a recording signal from the R/W channel 3 and outputs the amplified signal to the magnetic head 5. When data is reproduced, the head amplifier 4 amplifies a reproduced signal from the magnetic head 5 and outputs the amplified signal to the R/W channel 3.

When data is recorded, the magnetic head 5 magnetically records a recording signal input from the head amplifier 4 on the magnetic disk 8. When data is reproduced, the magnetic head 5 reproduces data from the magnetic disk 8 and outputs the reproduced data to the head amplifier 4.

When a control signal is input into the driver 6 from the MPU/HDC 1, the driver 6 drives the voice coil motor 7 to cause the magnetic head 5 to move on the magnetic disk 8.

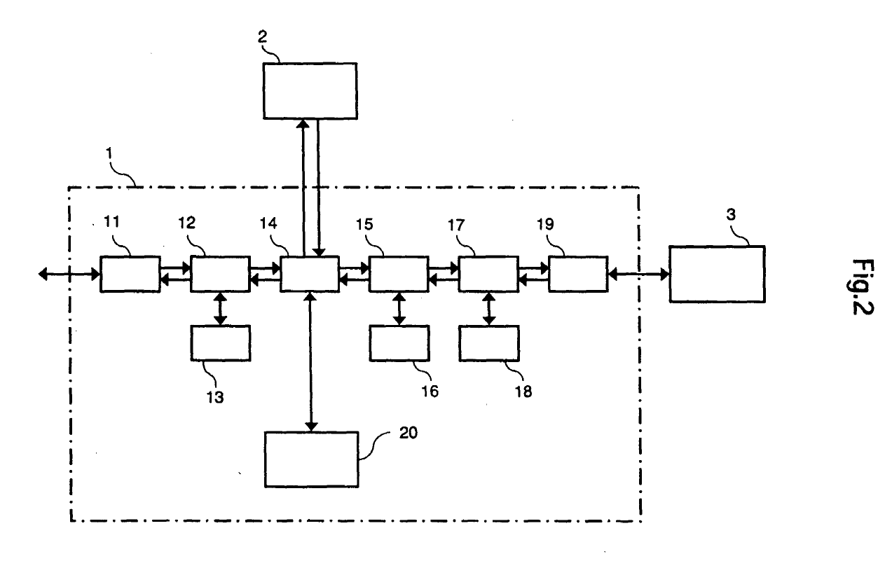

FIG. 2 is a block diagram illustrating an example of configuration of the MPU/HDC 1 included in the data recording apparatus 10. The MPU/HDC 1 includes a host interface 11, host side system ECC circuit 12, RAM 13, memory manager 14, drive side system ECC circuit 15, RAM 16, ECC circuit 17, RAM 18, drive controller 19 and micro processing unit (MPU) 20.

The host interface 11 functions as an interface with an external host.

The host side system ECC circuit 12 adds error detecting codes to recording data input from the host interface 11 to correct and check errors occurring in data transmitted in the system of the MPU/HDC 1 and analyzes the error detecting codes added to reproduced data transmitted in the system to correct and check errors.

An error correcting code (ECC) and a cyclic redundancy check (CRC) code are used as an error detecting code. The ECC is capable of detecting errors occurring in data and restoring data. The CRC code is capable of detecting errors occurring in data and used to prevent the ECC codes from erroneously detecting.

The error detecting code added and analyzed in the host side system ECC circuit 12 is used to correct and check errors occurring in data at a transmission line between the host side system ECC circuit 12 and the drive side system ECC circuit 15 (hereinafter, the error detecting code used for this purpose is referred to as “intra-system error detecting code”). The transmission line between the host side system ECC circuit 12 and the drive side system ECC circuit 15 refers to a transmission line between the host side system ECC circuit 12 and the memory manager 14, a transmission line between the memory manager 14 and the memory 2, inside of the memory 2, a transmission line between the memory 2 and the memory manager 14 and a transmission line between the memory manager 14 and the drive side system ECC circuit 15.

Specifically, the host side system ECC circuit 12 adds the intra-system error detecting code to each data sector (small sector, for example, 512 bytes) in a recording data input from the host interface 11 and outputs the data to the memory manager 14. The code is analyzed in the drive side system ECC circuit 15 to correct and check errors.

The host side system ECC circuit 12 analyzes the intra-system error detecting code added to reproduced data input from the memory manager 14 to correct or check errors and outputs the data to the host interface 11. The code is added in the drive side system ECC circuit 15.

The RAM 13 functions as a work memory of the host side system ECC circuit 12. The RAM 13 has enough capacity to store the data sector (small sector, for example, 512 bytes) handled by the host side system ECC circuit 12.

The memory manager 14 causes the memory 2 (buffer memory) to temporally store recording data transmitted from the host side system ECC circuit 12 to the drive side system ECC circuit 15 and reproduced data transmitted from the drive side system ECC circuit 15 to the host side system ECC circuit 12 by the control of the MPU 20.

The drive side system ECC circuit 15 performs: a first operation to analyze the intra system error detecting code (the error detecting code added in the host side system ECC circuit 12) added to the recording data input from the memory manager 14 to correct and check errors occurring in data transmitted in the system of the MPU/HDC 1; a second operation to output data strings in which a recording composite code is added to the aggregation of a plurality of data sectors (small sector) of the recording data to the ECC circuit 17; a third operation to obtain a verifying composite codes from the data string of reproduced data input from the ECC circuit 17 to detect errors; and a fourth operation to add the intra-system error detecting code (the error correcting code analyzed in the host side system ECC circuit 12) to the reproduced data and outputs the data to the memory manager 14.

As described above, the first and the fourth operation are used to correct and check errors occurring in data on the transmission line between the host side system ECC circuit 12 and the drive side system ECC circuit 15.

The second and the third operation are used to detect errors occurring in data on the transmission line between the drive side system ECC circuit 15 and the ECC circuit 17. These operations are described in detail later.

The RAM 16 functions as a work memory of the drive side system ECC circuit 15. The RAM 16 has enough capacity to store the data sector (small sector, for example, 512 bytes) handled by the drive side system ECC circuit 15.

The ECC circuit 17 performs: an operation to add an error detecting code (ECC and CRC codes) to the data string of the recording data input from the drive side system ECC circuit 15 to correct and check errors occurring in data transmitted on the transmission line from the MPU/HDC 1 to the magnetic disk 8 and in data recorded to and reproduced from the magnetic disk 8 and output the data to the drive controller 19; and an operation to analyze the error detecting code added to the data string of the reproduced data input from the drive controller 19. Hereinafter, the error detecting code thus added and analyzed in the ECC circuit 17 is referred to as “drive error detecting code.”

The data string input from the drive side system ECC circuit 15 is the aggregation of a plurality of data sectors (small sector) on which a recording composite code is added. The ECC circuit 17 and the circuits situated further downstream than the circuit 17 handle the data string as a recording unit (large sector) to the magnetic disk 8. In the present embodiment, the large sector is composed of eight small sectors.

The RAM 18 functions as a work memory of the ECC circuit 17. The RAM 18 has enough capacity to store the data string (large sector, for example, 4 k bytes) handled by the ECC circuit 17. That is to say, the RAM 18 has a capacity which is about eight times as large as that of the RAM 13 or RAM 16.

The drive controller 19 outputs the data string (on which the drive error detecting code is added in the ECC circuit 17) of the recording data input from the ECC circuit 17 to the R/W channel 3 to cause the magnetic head 5 to record data. When the data string of data reproduced by the magnetic head 5 is input from the R/W channel 3 into the drive controller 19, the drive controller 19 outputs it to the ECC circuit 17.

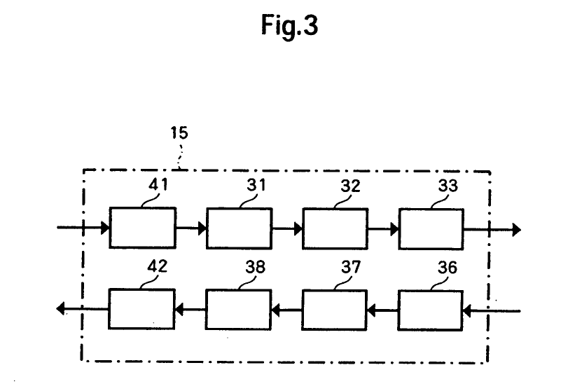

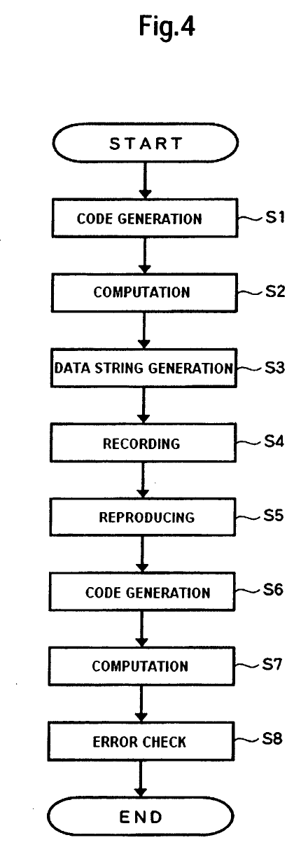

FIG. 3 is a block diagram illustrating an example of configuration of the drive side system ECC circuit 15 included in the MPU/HDC 1. FIG. 4 is a flowchart illustrating an example of operation of the drive side system ECC circuit 15.

The drive side system ECC circuit 15 includes a recording side code generating unit 31, recording side computing unit 32, data string generating unit 33, reproducing side code generating unit 36, reproducing side computing unit 37, error detecting unit 38, code analyzing unit 41 and code adding unit 42.

In the drive side system ECC circuit 15, the code analyzing unit 41 analyzes the intra-system error detecting code (the error correcting code added in the host side system ECC circuit 12) added to the recording data input from the memory manager 14 to correct or check errors (the first operation).

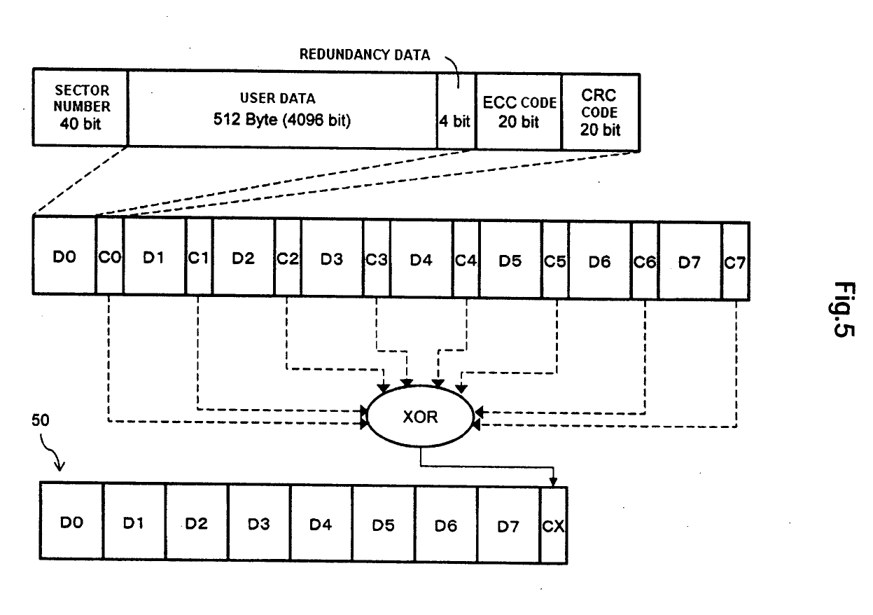

FIG. 5 is a drawing for describing a recording operation or the second operation at S1 to S3. The recording side code generating unit 31 generates error detecting codes (ECC and CRC codes) C0 to C7 from data sectors (small sectors) D0 to D7 of user data (recording data) to be recorded at S1. The recording side code generating unit 31 adds a redundant data of four bits to the data sector (512 Bytes) so that the data sector can be divided by 10 with 10 bits as one symbol, from which the ECC code of 20 bits are generated. The CRC code is taken as 20 bits.

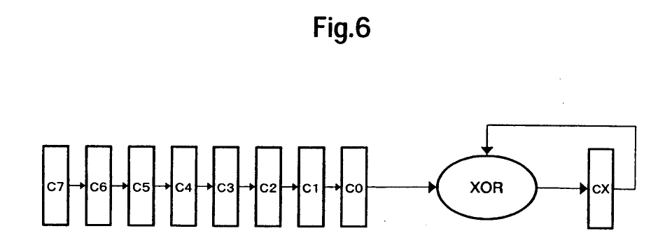

The recording side computing unit 32 performs a predetermined computation on the error detecting codes C0 to C7 generated from data sectors (small sectors) D0 to D7 included in the large sector to compute a recording composite code CX at S2. The recording side computing unit 32 sequentially executes XOR (Exclusive OR) of the corresponding digits of the error detecting codes C0 to C7, as shown in FIG. 6, to compute the recording composite code CX. This causes the recording composite code CX to be equal to each of the error detecting codes C0 to C7 in bit number (40 bits).

For computation given to the error detecting codes C0 to C7, it is not limited to XOR, but other logical operations may be used. If size can be reduced compared with the case where the error detecting codes C0 to C7 are connected, other computing methods may be used.

In the present embodiment, although both of the ECC and the CRC code are subjected to the logical operation to generate the recording composite code CX, any one of the codes may be subjected to the logical operation. Subjecting the ECC code to the logical operation to generate the recording composite code CX leads to loss of an error correction capability of the ECC code. For this reason, if the error correction capability is required, only the CRC code may be subjected to the logical operation. Even if the error correction capability of the ECC code is lost, a purpose to detect errors can be attained.

The data string generating unit 33 generates a data string 50 in which the recording composite code CX is added to the aggregation of a plurality of the data sectors (small sectors) D0 to D7 at S3. The data string 50 is taken as a recording unit (large sector) to the magnetic disk 8.

The data string 50 generated in the above manner is output to the ECC circuit 17. The data string 50 on which the drive error detecting code is further added in the ECC circuit 17 is output from the drive controller 19 and recorded on the magnetic disk 8 by the magnetic head 5 at S4, (or function as the data recording unit).

Since the recording composite code CX smaller in size than the case where the error detecting codes C0 to C7 generated from the data sectors D0 to D7 are connected to the data sectors (small sectors) D0 to D7 is added to the data string 50, enough capacity is ensured to record the user data on the magnetic disk 8.

The data string 50 recorded on the magnetic disk 8 is reproduced by the magnetic head 5, then the drive error detecting code is analyzed in the ECC circuit 17 to correct and check errors occurring in the data and thereafter the data string 50 is input into the drive side system ECC circuit 15 at S5 (or function as the data reproducing unit).

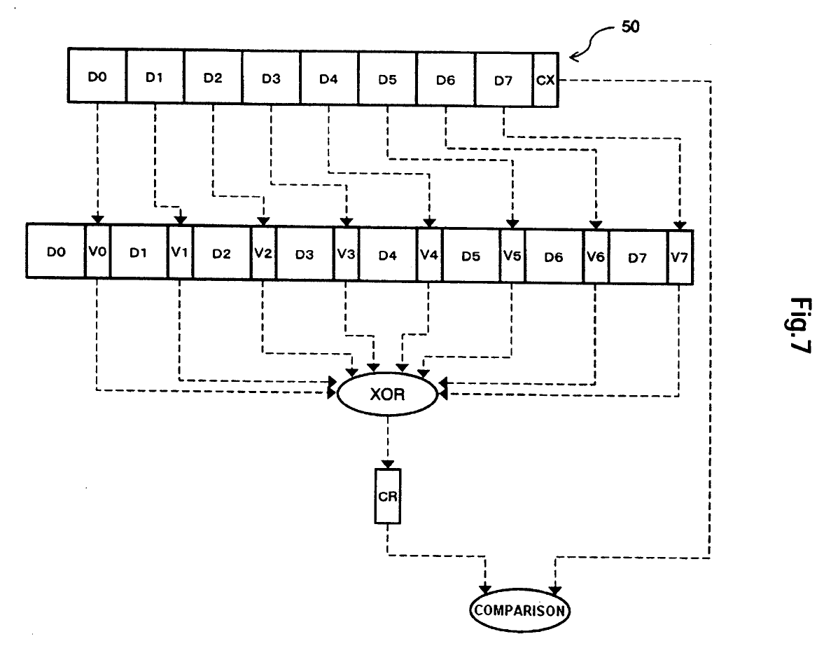

FIG. 7 is a drawing for describing a reproducing operation or the third operation at S6 to S8. The reproducing side code generating unit 36 generates verifying codes (ECC and CRC codes) V0 to V7 from the data sectors (small sectors) D0 to D7 included in the reproduced data string 50 in the same manner as the recording side code generating unit 31 at S6. The reproducing side computing unit 37 computes a verifying composite code CR from the verifying codes V0 to V7 in the same manner as the recording side computing unit 32 at S7. The error detecting unit 38 compares the computed verifying composite code CR with the recording composite code CX added on the data string 50. When both coincide with each other, the error detecting unit 38 determines that an error does not occur in the data sectors D0 to D7. When both fail to coincide with each other, the error detecting unit 38 determines that an error occurs in any of the data sectors D0 to D7 at S8 in the data string 50.

The verifying composite code CR is thus obtained from the data sectors D0 to D7 included in the reproduced data string 50 in the same manner as the recording composite code CX and compared with the recording composite code CX, thereby enabling determining whether an error occurs in the data sectors D0 to D7.

The code adding unit 42 adds the intra-system error detecting code (the error detecting code analyzed in the host side system ECC circuit 12) to each of the data sectors D0 to D7 and outputs them to the memory manager 14 (the fourth operation).

The drive side system ECC circuit 15 operates in such a manner as described above.

In the data recording apparatus 10 described above, as shown in FIG. 2, the drive side system ECC circuit 15 is located at the front stage of the ECC circuit 17 (at the front stage on the host side) which adds and analyzes an error detecting code (the drive error detecting code) to the data to correct and check errors occurs in data transmitted in the transmission line to the magnetic head 5 and on the magnetic disk 8.

The drive side system ECC circuit 15 is located at the front stage of the ECC circuit 17, which means that the recording composite code added in the drive side system ECC circuit 15 is used only on the transmission line between the drive side system ECC circuit 15 and the ECC circuit 17. This transmission line is sufficiently lower in a probability that an error occurs in data than a transmission line on which the intra-system error detecting code added in the host side system ECC circuit 12 and the drive error detecting code added in the ECC circuit 17 are used. For this reason, a high error correcting capability of the ECC code is not required on this the transmission line, so that the recording composite code can be obtained from the ECC code.

Although the present embodiment describes an example of configuration in which the drive side system ECC circuit 15 generates the error detecting code from each of the data sectors to be recorded (the recording side code generating unit 31), computes the recording composite code (the recording side computing unit 32), generates the data string (the data string generating unit 33), generates the verifying code from each of the data sectors included in the reproduced data string (the reproducing side code generating unit 36), computes the verifying composite code (the reproducing side computing unit 37) and detects errors (the error detecting unit 38), it is not limited to the above, for example, such a configuration may be applied to the ECC circuit 17.

In the present embodiment, although the recording composite code CX is computed by sequentially executing a logical operation (such as XOR) of the corresponding digits of the error detecting codes C0 to C7, performing calculation with each of the error detecting codes C0 to C7 multiplied by coefficients different in weighting allows detecting whether an error occurs in which data sector (small sector) in D0 to D7 at the time of detecting an error.

What is claimed is:

1. A data recording apparatus comprising:
a recording side code generating unit for uniquely generating a code from each data sector;
a recording side computing unit for performing a predetermined computation on the code to compute a recording composite code small in size than the codes connected with each other;
a data string generating unit for generating a data string in which the recording composite code is added to the aggregation of each data sector;
a data recording unit for recording the data string on a recording medium;
a data reproducing unit for reproducing the data string from the recording medium;
a reproducing side code generating unit for generating a verifying code from each data sector included in the reproduced data string in the same manner as the recording side code generating unit;
a reproducing side computing unit for computing a verifying composite code from the verifying code in the same manner as the recording side code generating unit; and
an error detecting unit for comparing the recording composite code with the verifying composite code to detect that an error occurs in the data sector if both fail to coincide with each other.

2. The data recording apparatus according to claim 1, wherein the recording side code generating unit generates an error correcting code and/or an error checking code smaller in size than the data sector as the code.

3. The data recording apparatus according to claim 1, wherein a predetermined number of data sectors are taken to be a recording unit for the recording medium, and the recording side computing unit computes the recording composite code for each of the predetermined number of data sectors.

4. A recording medium characterized in that a data string in which a recording composite code is added on the aggregation of each data sector is recorded on the recording medium, the recording composite code being computed in such a manner that a predetermined computation is executed on a code uniquely generated from each data sector to compose the data sectors and therefore being smaller in size than the codes connected with each other.

5. A method of detecting an error comprising the steps of:
uniquely generating a code from each data sector on a recording side;
performing a predetermined computation on the code on the recording side to compute a recording composite code smaller in size than the codes connected with each other;
generating a data string in which the recording composite code is added to the aggregation of each data sector;
recording the data string on a recording medium;
reproducing the data string from the recording medium;
generating a verifying code from each data sector included in the reproduced data string in the same manner as the recording side code generating unit;
computing a verifying composite code from the verifying code on the reproducing side in the same manner as the recording side computing unit; and
comparing the recording composite code with the verifying composite code to detect that an error occurs in the data sector if both fail to coincide with each other.
